(19) United States
(12) Patent Application Publication
(10) Pub. No.: US 2009/0020926 A1
(43) Pub. Date: Jan. 22, 2009

(54) INSULATING REFRACTORY LINING

(75) Inventors: Ronald L. Barrett, Fenelton, PA (US); Paul C. Sheil, Akron, OH (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: North American Refractories Co.

(21) Appl. No.: 11/778,929

(22) Filed: Jul. 17, 2007

(51) Int. Cl. B22D 41/02; B05D 7/00

(52) U.S. Cl. 266/280; 427/402

(57) ABSTRACT

An insulating refractory lining for insulating the inner surface of a vessel defined by a metal shell. The refractory lining is comprised of a first refractory layer overlaying an inner surface of a metal shell. The first refractory layer is comprised of a cast refractory material and has a first side facing the metal shell and a second side facing away from the metal shell. A plurality of discrete, spaced-apart cavities are formed in the first side of the first refractory layer. The cavities define air pockets between the metal shell and the first refractory layer.

### FIELD OF THE INVENTION

The present invention relates to refractory linings for vessels used in high-temperature applications.

### BACKGROUND OF THE INVENTION

It is known to line vessels, such as ladles and tundishes used in high-temperature applications, with refractory material to conserve energy and to protect metal structures.

A variety of refractory products and construction techniques have been developed to improve the insulating capacity of refractory linings. A common technique is to use insulating refractory brick and refractory monoliths. Generally, these insulating products contain low-density aggregates such as expanded clay, perlite, vermiculite, bubble alumina or other materials. The type of low-density aggregate used often determines the temperature limits of the product. While effective, insulating brick and monoliths are relatively high-porosity materials that, in many cases, are not suitable for use as “hot face” materials. In this respect, their high porosity makes them vulnerable to attack by constituents in the operating environment of the particular processing unit in which they are used. As such, they are often—but not always—used as backup linings, with a denser, less-vulnerable refractory being used as the hot-face refractory in contact with the high-temperature operating environment of the unit.

Ceramic fiber has also been used as an insulating material. Ceramic fiber has been employed as blankets, modules, and a constituent in spray mixes and gunning mixes. Like the insulating brick and monoliths, products based on ceramic fibers, or products containing a substantial amount of fiber, tend to have high porosities and are thus not suitable for use in the operating environments of many high-temperature industrial processes.

In various applications, air gaps have been employed to provide an insulating barrier. For example, rotary cement kiln brick with a recess on the cold face has been used. These recesses create an air gap over a portion of the cold face of the brick and provide a degree of insulation. Economical means of introducing air gaps behind monolithic refractory linings have not been developed.

### SUMMARY OF THE INVENTION

In accordance with the present invention, there is provided an insulating refractory lining for insulating the inner surface of a vessel defined by a metal shell. The refractory lining is comprised of a first refractory layer overlaying an inner surface of a metal shell. The first refractory layer has a first side facing the metal shell and a second side facing away from the metal shell. A plurality of discrete, spaced-apart cavities are formed in the first side of the first refractory layer. The cavities define air pockets between the metal shell and the first refractory layer.

In accordance with another aspect of the present invention, there is provided an insulating refractory lining, comprised of a first refractory layer having a first side and a second side. A second refractory layer is disposed on the second side of the first refractory layer. A plurality of discrete, spaced-apart cavities are defined between the first refractory layer and the second refractory layer.

In accordance with yet another aspect of the present invention, there is provided a method of forming discrete, spaced-apart air pockets in a refractory lining, comprising the steps of:

applying a polymer sheet material onto a rigid surface, the surface sheet material having a plurality of discrete, spaced-apart air pockets formed on one side thereof wherein the air pockets are disposed on the side of the sheet material that is facing away from the rigid surface; and

casting a refractory material on the polymer sheet wherein the air pockets form cavities in the side of the refractory material facing the polymer sheet.

An advantage of the present invention is an insulating refractory lining for vessels used in high-temperature applications.

Another advantage of the present invention is an insulating refractory lining as described above, having discrete air pockets formed therein.

Another advantage of the present invention is an insulating refractory lining as described above, wherein the discrete air pockets are formed along a support structure on the cold side of the refractory lining.

Another advantage of the present invention is a method of forming air cavities in an insulating refractory lining.

### BRIEF DESCRIPTION OF THE DRAWINGS

FIG. 1 is a partially sectioned, elevational view of a tundish, showing an insulating refractory lining according to the present invention;

FIG. 2 is an enlarged sectional view of the insulating refractory lining shown in FIG. 1;

FIG. 3 is a sectional view of an insulating material used in forming the insulating refractory lining shown in FIG. 1;

FIG. 4 is a sectional view, showing the insulating material of FIG. 3 positioned between a metal layer and a refractory material;

FIG. 5 is a sectional view of an insulating refractory lining before heat is applied, illustrating another embodiment of the present invention;

FIG. 6 is a sectional view of the insulating refractory lining of FIG. 5 shown after heat is applied;

FIG. 7 is a sectional view of an insulating refractory lining, illustrating another embodiment of the present invention; and

FIG. 8 is a sectional view of an insulating refractory lining, illustrating yet another embodiment of the present invention.

### DETAILED DESCRIPTION OF PREFERRED EMBODIMENT

Referring now to the drawings wherein the showings are for the purpose of illustrating preferred embodiments in the invention only and not for the purpose of limiting same, FIG. 1 shows a conventional tundish 10 for use in a steel-making process. A ladle shroud 12 is shown above tundish 10 to direct a stream 14 of molten metal (from a ladle not shown) into tundish 10 to form a molten metal bath 16. Tundish 10 includes a pair of well blocks 18 having opening 18a extending therethrough to allow molten metal from bath 16 to enter molds (not shown) as conventionally known. Tundish 10 has an outer metal shell 22 and an insulating refractory lining 32 disposed on the inner surface of metal shell 22. A layer 19 of a plastic refractory or ramming mix fills any gap between well block 18 and refractory lining 32.

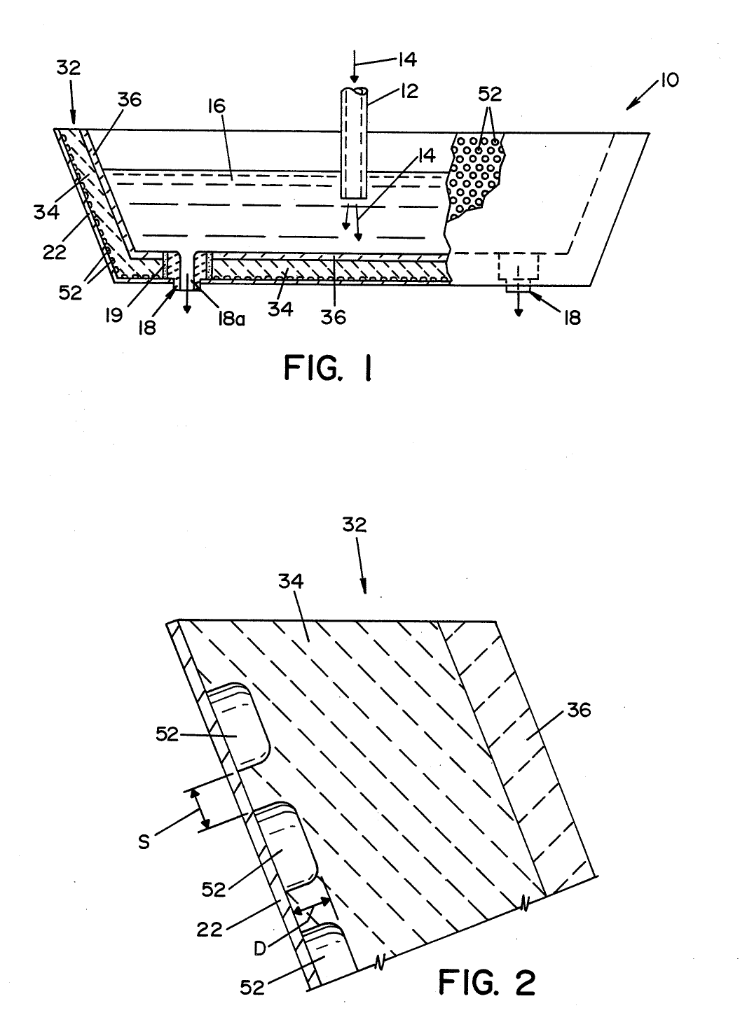

Referring now to FIG. 2, refractory lining 32 is best shown. Refractory lining 32 is comprised of a first refractory layer 34 positioned adjacent metal shell 22 and a second refractory layer 36 formed adjacent to and along the surface of first refractory layer 34. In one embodiment, first refractory layer 34 is a castable refractory that is formed along the inner surface of metal shell 22. First refractory lining 34 is formed against metal shell 22, using forms, as is conventionally known. The second refractory lining may be a material applied by wet spraying or as a dry vibratable material.

As shown in FIG. 2, a plurality of spaced-apart, discrete air cavities or air pockets 52 are formed between first refractory layer 34 and metal shell 22 of tundish 10. In the embodiment shown, air cavities 52 are generally cylindrical in shape. More specifically, cavity 52 has a generally cylindrical side portion 52a and a flat bottom portion 52b. Side portion 52a is connected to bottom portion 52b by a radiused or contoured corner 52c. In one embodiment of the present invention, cavity 52 is dimensioned wherein cylindrical portion 52a has a diameter “D” of about 1 inch. Cavity 52 has a depth “d” equal to about ½ inch. It is contemplated that the depth of cavity 52 may vary. Cavity 52 may have a diameter “D,” ranging from about ¼ inch to about 3 inches, and a depth “d,” ranging from about ¼ inch to about 2 inches. A spacing “S” between adjacent cavities 52 ranges from about 1/32 inch to about 2 inches. Air cavities 52 are essentially voids formed in first refractory layer 34 to provide insulation between metal shell 22 and first refractory layer 34.

Cavities 52 are dimensioned, and are of such numbers, as to produce a “cavity density” of between about 6 cavities 52 and about 1,762 cavities 52 per square foot along the inner surface of metal shell 22.

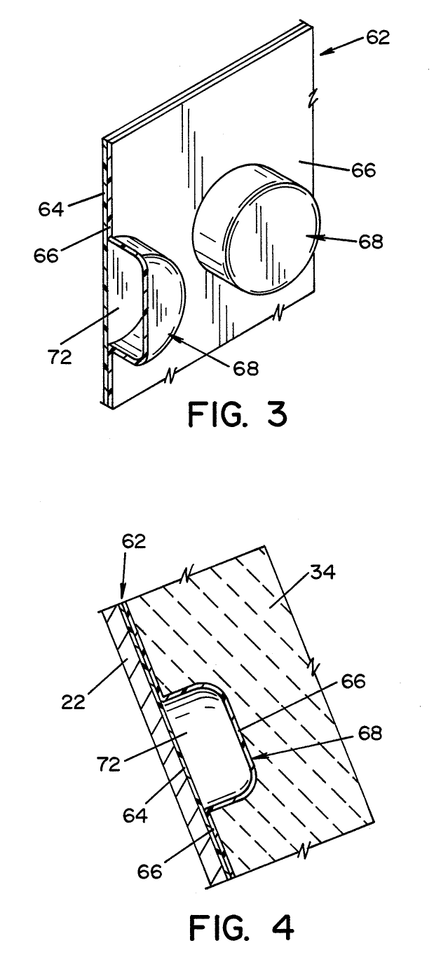

The present invention shall now be further described with respect to a method of forming insulating refractory lining 32. Insulating refractory lining 32 is formed on a metal shell 22 of a vessel by first applying a layer of a sheet material 62, best seen in FIG. 3, onto the inner surface of metal shell 22. Sheet material 62 has a plurality of discrete, spaced-apart air pockets formed on one side thereof. Sheet material 62 is basically comprised of two (2) layers 64, 66, both of a polymer material, that are joined together along sides thereof to form a single sheet material 62. A plurality of spaced-apart, generally cylindrical recesses or rounds 68 are formed in layer 66, as illustrated in FIG. 3. These recesses 68 in layer 66 produce air pockets or air cavities 72 between layers 64, 66 when layers 64 and 66 are joined together.

Layers 64, 66 are preferably formed of a polymeric material, wherein sheet material 62 has a thickness of about 1.25 mils in the areas between rounds 68. In one embodiment of the present invention, sheet material 62 is comprised of Bubble Wrap® air cellular cushion sheet, manufactured by Sealed Air Corporation of Saddlebrook, N.J.

With sheet material 62 in place on metal shell 22, first refractory layer 34 is formed adjacent sheet material 62. As indicated above, first refractory layer 34 is preferably a castable material that is cast in place over sheet material 62. As illustrated in FIG. 4, the air pockets 72 in sheet material 62 form cavities 52 in the surface of first refractory layer 34. First refractory layer 34 may be formed in metal shell 22 using forms, as is conventionally known with castable materials. First refractory layer 34 is preferably formed of a dense, high-temperature castable material, such as, by way of example and not limitation, NARCON 70, manufactured by North American Refractories Company, Cherrington Corporate Center, 400 Fairway Drive, Moon Township, Pa. 15108 U.S.A.

Once first refractory layer 34 has cured and hardened, forms may be removed and second refractory layer 36 may be applied thereto. Second refractory layer 36 represents a hot face material, and preferably consists of a sprayed refractory material or a dry, vibratable refractory material.

Referring now to the operation of insulating refractory lining 32, FIG. 1 illustrates refractory lining 32 in a tundish 10 for receiving molten metal. In the embodiment shown in FIGS. 1-4, i.e., where insulating refractory lining 32 lines a tundish 10, second refractory layer 36 represents the hot face of lining 32 that is exposed directly to the molten metal bath 16. First refractory layer 34 is conventionally referred to as a “backup lining.” Second refractory layer 36 is conventionally referred to as a “working lining.” Both second refractory layer 36 and first refractory layer 34 experience high temperatures as a result of exposure to molten metal bath 16. Sheet material 62, being formed of a polymeric material, may thermally degrade or oxidize during use of tundish 10 as a result of exposure to heat from molten metal bath 16. FIG. 2 illustrates insulating refractory lining 32 wherein sheet material 62 has degraded and oxidized, and therefore is no longer present in a structural form. Although sheet material 62 is no longer present, air pockets 52 remain, having been formed in the hardened refractory material forming first refractory lining 34. Air pockets 52 disposed between metal shell 22 and first refractory layer 34 provide an insulating effect between metal shell 22 and first refractory layer 34. In this respect, heat energy is stored in molecules as vibrations. Higher temperatures produce more vibrations. The reduced number of molecules present within an air pocket 52 retards transfer of energy from one molecule to another thereby producing an improved insulating effect where an air pocket 52 exists.

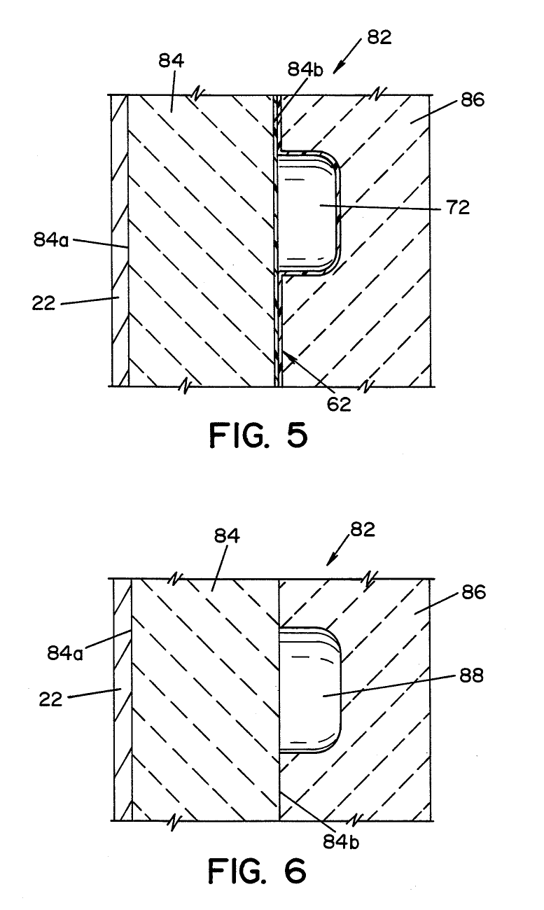

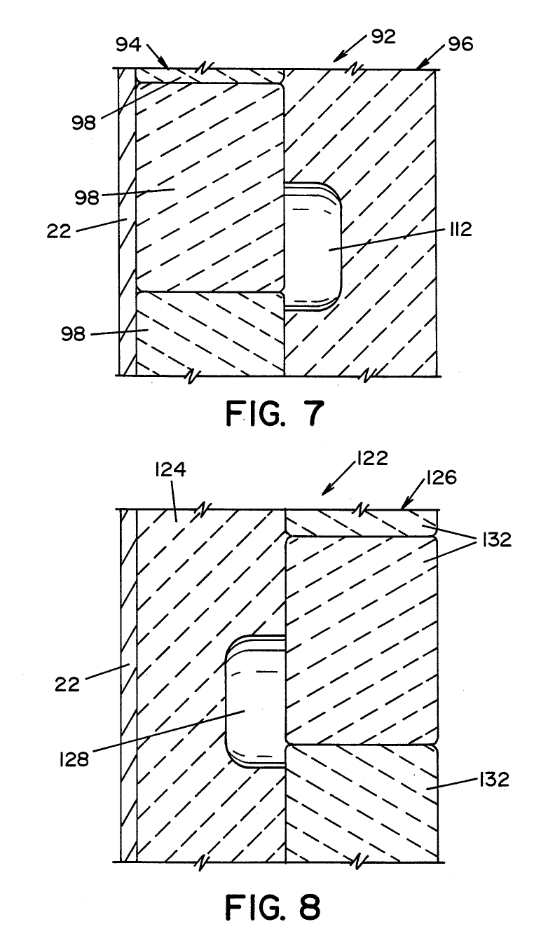

Referring now to FIGS. 5 and 6, an insulating refractory lining 82, illustrating an alternate embodiment of the present invention is shown. Insulated refractory lining 82 is comprised of a first refractory layer 84 and a second refractory layer 86. First refractory lining 84 is formed along metal shell 22. In the embodiment shown, first refractory layer 84 is formed of a cast material, as previously described. First refractory layer 84 has a first side 84a facing metallic shell 22 and a second side 84b facing away from metal shell 22. Sheet material 62 having air pockets 72 is applied to second side 84b of first refractory layer 84. Second refractory layer 86 is then formed over sheet layer 62 by a casting. In this manner, discrete cavity 88 may be formed between refractory layers 84, 86, as illustrated in FIG. 6. FIG. 6 illustrates insulating refractory lining 82 shown in FIG. 5, after heating wherein sheet material 62 has deteriorated, leaving refractory layers 84, 86 with cavity 88 formed therebetween.

Whereas FIGS. 5 and 6 disclose cavities 88 and air pockets 72 formed between adjacent layers 84, 86 of cast refractory materials, it will likewise be appreciated that air pockets may be formed between a layer of refractory bricks and a layer of cast material. In this respect, FIG. 7 illustrates an insulating refractory lining 92 having a first refractory layer 94 and a second refractory layer 96. Refractory layer 94 is comprised of a layer of refractory bricks 98. Bricks 98 are disposed along the surface of metal shell 22. A layer of sheet material 62, not shown in FIG. 7, is then applied over bricks 98. Second refractory layer 96 is comprised of a refractory castable, and is cast over sheet material 62. Air pockets 112 are formed between first refractory layer 94 and second refractory layer 96.

FIG. 8 shows an insulating refractory lining 122 illustrating another embodiment of the present invention. Refractory lining 122 is comprised of a first refractory layer 124 and a second refractory layer 126. In the embodiment shown in FIG. 8, first refractory layer 124 is comprised of a cast refractory material, and is formed along metal shell 22. To form first refractory layer 124, forms (not shown) are used. Sheet material 62 (not shown in FIG. 8) is disposed along the surface of the forms such that cavity 128 is formed in the surface of first refractory layer 124 while first refractory layer 124 is being formed. Thereafter, when the form is removed, sheet material 62 is likewise removed leaving cavity 128 in the face of first refractory layer 124. Second refractory layer 126 is comprised of refractory bricks 132. Bricks 132 are applied over the surface of the cast refractory material that forms first refractory layer 124. Insulating refractory lining 122 is thus comprised of a cast, first refractory layer 124 and a brick, second refractory layer 126 having at least one air cavity 128 defined therebetween.

The foregoing description is a specific embodiment of the present invention. It should be appreciated that this embodiment is described for purposes of illustration only, and that numerous alterations and modifications may be practiced by those skilled in the art without departing from the spirit and scope of the invention. For example, it is contemplated that sheet material 62 may be formed by bubbles or air pockets of different shapes than the generally cylindrical shape shown in the drawings. In this respect, it is contemplated that recesses 68 in sheet material 62 may be semi-spherical or even parabolic. It is intended that all such modifications and alterations be included insofar as they come within the scope of the invention as claimed or the equivalents thereof.

Having described the invention, the following is claimed:

1. An insulating refractory lining for insulating the inner surface of a vessel defined by a metal shell, said refractory lining comprised of:
a first refractory layer overlaying an inner surface of a metal shell, said first refractory layer having a first side facing said metal shell and a second side facing away from said metal shell; and
a plurality of discrete, spaced-apart cavities formed in said first side of said first refractory layer, said cavities defining air pockets between said metal shell and said first refractory layer.

2. An insulating refractory lining as defined in claim 1, wherein said cavities are generally cylindrical in shape.

3. An insulating refractory lining as defined in claim 1, wherein said cavities have a density ranging between about 6 and about 1,764 cavities per square foot.

4. An insulating refractory lining as defined in claim 1, wherein said cavities have a depth of about ¼ inch to about 2 inches.

5. An insulating refractory lining as defined in claim 4, wherein said cavities define an opening ranging from about ¼ inch to about 3 inches.

6. An insulating refractory lining as defined in claim 1, further comprising a second refractory layer disposed on said second side of said first refractory layer.

7. An insulating refractory lining as defined in claim 6, wherein said second refractory layer is a sprayed refractory material.

8. An insulating refractory lining as defined in claim 6, wherein said second refractory layer is a dry, vibratable refractory material.

9. An insulating refractory lining as defined in claim 1, further comprising a polymeric sheet material disposed between said metal shell and said first refractory layer, said polymeric sheet material having a plurality of discrete, spaced-apart air pockets formed therein, said air pockets in said polymeric sheet material defining said cavities.

10. An insulating refractory lining as defined in claim 1, wherein said first refractory layer is formed by casting, spraying or gunning.

11. An insulating refractory lining, comprised of:
a first refractory layer having a first side and a second side;
a second refractory layer disposed on said second side of said first refractory layer; and
a plurality of discrete, spaced-apart cavities defined between said first refractory layer and said second refractory layer.

12. An insulating refractory lining as defined in claim 11, wherein said first refractory layer is comprised of refractory brick and said second refractory layer is a cast refractory material, said cavities being formed in said second refractory layer.

13. An insulating refractory lining as defined in claim 11, further comprising a polymeric sheet material disposed between said first refractory layer and said second refractory layer, said polymeric sheet material having a plurality of discrete, spaced-apart air pockets formed therein, said air pockets in said polymeric sheet material forming said cavities.

14. An insulating refractory lining as defined in claim 13, wherein said second refractory layer is cast over said polymeric sheet material.

15. An insulating refractory lining as defined in claim 11, wherein said cavities have a density ranging between about 6 and about 1,764 cavities per square foot.

16. An insulating refractory lining as defined in claim 11, wherein said cavities have a depth of about ¼ inch to about 2 inches.

17. An insulating refractory lining as defined in claim 11, wherein said first refractory layer is comprised of a cast refractory material and said second refractory layer is a cast refractory material.

18. An insulating refractory lining as defined in claim 17, further comprising a polymeric sheet material disposed between said first refractory layer and said second refractory layer, said polymeric sheet material having a plurality of discrete, spaced-apart air pockets formed therein, said air pockets in said polymeric sheet material forming said cavities.

19. An insulating refractory lining as defined in claim 18, wherein said second refractory layer is cast over said polymeric sheet material.

20. An insulating refractory lining as defined in claim 17, wherein said polymeric sheet material is Bubble Wrap®.

21. An insulating refractory lining as defined in claim 11, wherein said first refractory layer is disposed on a metal shell of a metallurgical vessel for holding molten material.

22. A method of forming discrete, spaced-apart air pockets in a refractory lining, comprising the steps of:
applying a polymer sheet material onto a rigid surface, said sheet material having a plurality of discrete, spaced-apart air pockets formed on one side thereof wherein said air pockets are disposed on the side of said sheet that is facing away from said rigid surface; and
forming a layer of a refractory material on said polymer sheet wherein said air pockets form cavities in the side of said refractory material facing said polymer sheet.

23. A method as defined in claim 22, wherein said rigid surface is one side of a metal plate.

24. A method as defined in claim 22, wherein said rigid surface is a refractory layer.

25. A method as defined in claim 24, wherein said refractory layer is comprised of a cast refractory material.

26. A method as defined in claim 25, wherein said refractory layer is comprised of refractory bricks.

27. A method as defined in claim 22, wherein said rigid surface is a form defining one side of a refractory layer.

28. A method as defined in claim 22, wherein said layer of a refractory material is applied by casting, spraying or gunning.
